(19) United States
(12) Patent Application Publication
(10) Pub. No.: US 2009/0240991 A1
(43) Pub. Date: Sep. 24, 2009

(54) Automation device with diagnosis functionality

(75) Inventors: Gerd Branndmahl-Estor, Hemhofen (DE); Wemer Heda, Hochstadt (DE); Klaus peter Hoffman, Aurachtal-Munchaurach (DE); Robert Winter, Velburg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 12/381,891

(22) Filed: Mar. 17, 2009

(30) Foreign Application Priority Data
Mar. 19, 2008 (EP) 08005174.1

(51) Int. Cl. G06F 11/34

(52) U.S. Cl. 714/47; 714/E11.2

(57) ABSTRACT

An automation device having a diagnosis program for detecting operating and/or error statuses in hardware and/or software components of the automation device is disclosed. The diagnosis program is included in a Basic Input Output System of the automation device.

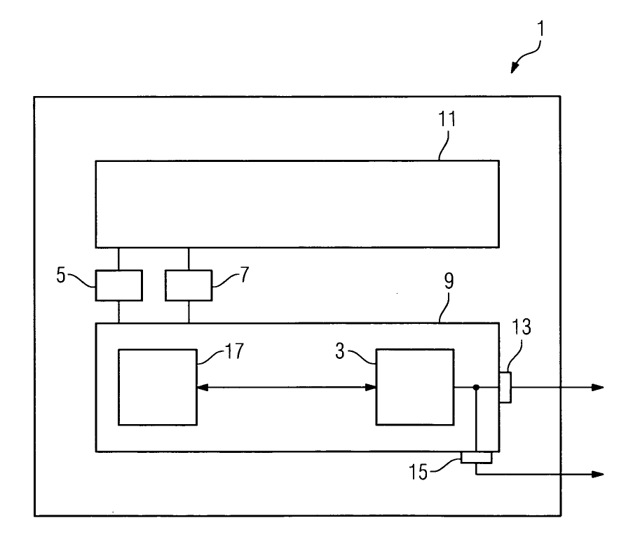

### CROSS REFERENCE TO RELATED APPLICATIONS

This application claims priority of European Patent application No. 08005174.1 EP filed Mar. 19, 2008, which is incorporated by reference herein in its entirety.

### FIELD OF INVENTION

The invention relates to an automation device, wherein a diagnosis of operating and/or error statuses in hardware and/or software components of the automation device is to be enabled.

### BACKGROUND OF INVENTION

Modern factories and production facilities, but also more and more increasingly the private sector without automation devices is barely imaginable.

Automation devices are used here for instance to automate a complex manufacturing process, in order to improve the quality of the manufacturing process for instance but also to reduce costs or the risks involved for the operating personnel.

As automation devices, for instance programmable logic controllers (PLC), are processor-assisted devices, such devices indicate the known, unfortunately also unwanted behavior of computer systems, during which software conflicts or hardware problems may occur.

Errors of this type may result in the automation device crashing completely, as a result of which the completely automated process is then interrupted.

The causes behind crashes of this type may lie in the hardware, but also in the software, but may also be caused by an interaction of the two. Diagnosis software is often required to find the causes of errors of this type, which collects the different operating statuses and data occurring from the hardware and software components of the automation device, and provides it for evaluation and/or undertakes the evaluation itself.

Automation devices mostly have a so-called firmware, in other words to some extent a special operating system for the automation device. The diagnosis software may then be formed as part of this firmware for instance. Alternatively, diagnosis software is also known as an independent, separate software module, which has to be loaded onto the automation device via a storage means.

### SUMMARY OF INVENTION

The disadvantage with these known solutions is that the essential hardware components of the automation device still have to function insofar as the firmware can be loaded or the separately formed software modules can still be loaded with the diagnosis software.

The firmware and/or the separate diagnosis software module must also still be functional insofar as diagnosis data is also able to accumulate and be provided. This is nevertheless not guaranteed at least with some errors.

An object of the invention is to specify an automation device with improved diagnosis functionality. In particular, the diagnosis functionality is to be available in respect of as many different errors as possible, in other words cannot be affected by errors.

The object is achieved in accordance with the invention by an automation device including at least one diagnosis program for detecting operating and/or error statuses in hardware and/or software components of the automation device, with the diagnosis program being contained in a Basic Input Output System (BIOS) of the automation device.

With the automation device, the diagnosis program is thus realized as part of the BIOS. The BIOS is very close to the hardware and is imprinted to a certain degree thereupon, where diagnosis data is to be retrieved and with which mechanism this data is to be made available. In simple terms, an error, in conjunction with an automation device, can now relate to a lot of “peripheries” of the automation device, without losing the diagnosis functionality. For instance, even the firmware of the automation device can now be defective without the diagnosis functionality getting lost.

The Basic Input Output System (BIOS) is preferably embodied as an Extensible Firmware Interface (EFI). The EFI is a specification for BIOS software, which allows very simple and user-friendly software module to be incorporated into a BIOS, without firmware or operating system peripheries having to be put into operation.

One advantage of the automation device consists in the diagnosis program now no longer having to be loaded separately. The diagnosis program is to a certain degree part of the hardware (as part of the BIOS) and is thus almost always available.

A further advantage consists in parts of the hardware, the firmware or another software module not having to be executable for diagnosis purposes and nevertheless the diagnosis functionality is available by means of the diagnosis program implemented in the BIOS.

In a further preferred embodiment, the Basic Input Output System also includes a storage region, preferably a non-volatile storage region, for storing the detected operating and/or error statuses.

With this embodiment, the stored operating and/or error statuses are stored particularly securely, since they are also stored within the BIOS. This data can thus not get lost in the event of a lot of errors.

In a further embodiment, the diagnosis program includes a TCP/IP interface so that the detected operating and/or error statuses can be transmitted by means of an internet connection.

Alternatively or in addition, the diagnosis program can include an Ethernet interface, so that the detected operating and/or error statuses can be transmitted by means of a local data connection.

With the said embodiment, the automation device makes the diagnosis data available to its environment. For instance, this diagnosis data can then be examined in a detailed fashion by means of an external evaluation computer and/or evaluation program.

In this way, the diagnosis program, which, as part of the BIOS, now almost belongs to the hardware, can collect and relay diagnosis data at least in respect of a subset of the hardware components belonging to the automation device. For instance, the diagnosis program reads out a diagnosis buffer (storage region), which has described a defective firmware in the automation device. The automation device then makes the diagnosis data available to its environment by way of a direct BIOS Ethernet connection, for instance for a local evaluation computer, which is connected to the automation device by means of an Ethernet connection.

### BRIEF DESCRIPTION OF THE DRAWING

An exemplary embodiment of the invention is shown in more detail below, in which:

FIGURE shows an automation device with diagnosis functionality.

### DETAILED DESCRIPTION OF INVENTION

An automation device 1 is shown schematically in the FIGURE, including a number of hardware components 5 and a number of software components 7.

A firmware 11 is provided in order to operate the automation device 1. This firmware 11 can be loaded onto the automation device 1 by means of a pluggable non-volatile storage device for instance. Or the firmware 11 is part of a non-volatile storage device included in the automation device 1, for instance integrated ROMs.

The automation device 1 also includes a Basic Input Output System (BIOS) 9.

The Basic Input Output System 9 includes a diagnosis program 3 for detecting operating and/or error statuses in the hardware 5 and/or software components 7 of the automation device 1.

The operating and/or error statuses are stored as diagnosis data in a storage region 17. This storage region 17 is preferably a non-volatile storage region 17, which is likewise included in a Basic Input Output System 9.

The diagnosis program 3 can now easily read the diagnosis data out of the storage region 17 and can transmit it to the outside world for additional evaluation purposes by means of a TCP/IP interface 13 and/or an Ethernet interface 15 for instance.

An error in the firmware 11 or in a hardware component 5 of the automation device 1 generates a diagnosis buffer entry in the storage region 17 for instance. Error entries of this type in the storage region 17 can then be read directly via the Basic Input Output System 9. The storage region 17, as an error storage device, is then to be queried in a simple fashion by way of the TCP/IP interface 13 and/or by way of the Ethernet interface 15.

In summary, it is thus possible to determine that the implementation of the diagnosis program 3 is “error tolerant” in the Basic Input Output System 9 of the automation device 1 such that the diagnosis functionality of the automation device 1 is still always available in the event of a lot of different errors.

1.-5. (canceled)

6. An automation device comprising:
a diagnosis program configured to detect operating statuses in components of the automation device; and
a Basic Input Output System,
wherein the diagnosis program is included in the Basic Input Output System, and
wherein the Basic Input Output System also includes a storage region configured to store the detected operating statuses.

7. An automation device comprising:
a diagnosis program configured to detect error statuses in components of the automation device; and
a Basic Input Output System,
wherein the diagnosis program is included in the Basic Input Output System, and
wherein the Basic Input Output System also includes a storage region configured to store the detected error statuses.

8. An automation device comprising:
a diagnosis program configured to detect operating statuses and error statuses in components of the automation device; and
a Basic Input Output System,
wherein the diagnosis program is included in the Basic Input Output System, and
wherein the Basic Input Output System also includes a storage region configured to store the detected operating statuses and error statuses.

9. The automation device as claimed in claim 6, wherein the components are selected from the group consisting of hardware component, software component and a combination thereof.

10. The automation device as claimed in claim 7, wherein the components are selected from the group consisting of hardware component, software component and a combination thereof.

11. The automation device as claimed in claim 8, wherein the components are selected from the group consisting of hardware component, software component and a combination thereof.

12. The automation device as claimed in claim 6, wherein the storage region is a non-volatile storage region.

13. The automation device as claimed in claim 7, wherein the storage region is a non-volatile storage region.

14. The automation device as claimed in claim 8, wherein the storage region is a non-volatile storage region.

15. The automation device as claimed in claim 6, wherein the diagnosis program has a TCP/IP interface so that the detected operating statuses are transmitted by an internet connection.

16. The automation device as claimed in claim 7, wherein the diagnosis program has a TCP/IP interface so that the detected error statuses are transmitted by an internet connection.

17. The automation device as claimed in claim 8, wherein the diagnosis program has a TCP/IP interface so that the detected operating statuses and error statuses are transmitted by an internet connection.

18. The automation device as claimed in claim 6, wherein the diagnosis program has an Ethernet interface so that the detected operating statuses are transmitted by a local data connection.

19. The automation device as claimed in claim 7, wherein the diagnosis program has an Ethernet interface so that the detected error statuses are transmitted by a local data connection.

20. The automation device as claimed in claim 8, wherein the diagnosis program has an Ethernet interface so that the detected operating statuses and error statuses are transmitted by a local data connection.

21. The automation device as claimed in claim 6, wherein the Basic Input Output System is an Extensible Firmware Interface.

22. The automation device as claimed in claim 7, wherein the Basic Input Output System is an Extensible Firmware Interface.

23. The automation device as claimed in claim 8, wherein the Basic Input Output System is an Extensible Firmware Interface.
